(19) United States
(12) Patent Application Publication
(10) Pub. No.: US 2024/0308845 A1
(43) Pub. Date: Sep. 19, 2024

(54) METHOD OF SAFE OPERATION OF A REFORMER WITH VARIOUS HYDROCARBON MIXTURES

(71) Applicants: thyssenkrupp Uhde GmbH, Dortmund (DE); thyssenkrupp AG, Essen (DE)

(72) Inventor: Christoph MEISSNER, Luenen (DE)

(73) Assignees: thyssenkrupp Uhde GmbH, Dortmund (DE); thyssenkrupp AG, Essen (DE)

(21) Appl. No.: 18/604,261

(22) Filed: Mar. 13, 2024

(30) Foreign Application Priority Data
Mar. 14, 2023 (DE) 10 2023 106 377.4
Mar. 14, 2023 (LU) LU 103087

(51) Int. Cl. C01B 3/34

(52) U.S. Cl. CPC C01B 3/34; C01B 2203/0216; C01B 2203/1235; C01B 2203/1657; C01B 2203/168

(57) ABSTRACT

The present disclosure relates to a method of operating a reformer, wherein the reformer is operated at least with a first hydrocarbon mixture and a second hydrocarbon mixture. The reformer has a primary reformer that is supplied with a first gas stream. The reformer also has a secondary reformer that is supplied with a semifinished product gas stream from the primary reformer and with an air stream. The first gas stream and the air stream are used to form the quotient of the first gas stream divided by the air stream. A threshold value is defined, wherein the reformer is shut down below the threshold value. The threshold value is compared with the product of the quotient of the first gas stream divided by the air stream multiplied by a factor H, wherein the factor is defined depending on the chemical composition of the gas stream.

### CROSS REFERENCE TO RELATED APPLICATION

This application is a U.S. Non-Provisional that claims priority to German Patent Application No. DE 10 2023 106 377.4, filed Mar. 14, 2023, and Luxembourg Patent Application No. LU 103087, filed Mar. 14, 2023, and the entire content of which is incorporated herein by reference.

### FIELD

The disclosure relates generally to a method of operating a reformer, such as a secondary reformer, autothermal reformer and POX reformer. The method includes operating the reformer with differing natural gas compositions.

### BACKGROUND

A reformer, consisting of a primary reformer and a secondary reformer, serves for production of hydrogen, for example from natural gas. In a first step, steam reforming is effected in the primary reformer, which is followed by a second step comprising a partial oxidation in the secondary reformer. The secondary reformer is usually an autothermal reformer. The primary reformer used may also be what is called a pre-reformer, or the pre-reformer may consist of a pre-reformer and a steam reformer. This is particularly standard for a subsequent ammonia synthesis. For this purpose, the natural gas is first subjected to thermal treatment in a primary reformer. Air is typically fed in upstream of a secondary reformer. This firstly introduces oxygen for combustion of natural gas and hence for the provision of heat, and secondly nitrogen which is required as the second reactant for ammonia synthesis. Ideally, the reformer is followed by a CO conversion and a removal of carbon dioxide, such that thereafter, in the ideal case, there is a gas mixture of hydrogen and nitrogen in a ratio (referred to hereinafter as H:N ratio) of ˜3:1.

Therefore, the gas-air ratio (amount of natural gas supplied to the primary reformer to amount of air supplied to the secondary reformer) is relevant and is typically used for closed-loop control. This ratio is typically varied during operation, for example in the event of an altered natural gas composition. In this respect, it is customary to realize a compensation for pressure and temperature since what are measured and controlled here are usually volume flows and not mass flows. If too much air is supplied, this causes an incorrect H:N ratio in the later synthesis gas, which may be unsuitable or usable much less efficiently as the case may be. In addition, in particular, an increase in the temperature in the secondary reformer occurs, which leads to damage in the plant. Since the temperature can become critical, a limit is defined on the plant side for the gas-air ratio, with automatic shutdown in the event that the value goes below it, in order to protect the apparatus from damage.

DE 10 2022 200 572 discloses an illustrative ammonia plant.

A plant is typically designed here for a particular natural gas composition. If a plant is fed from an adjacent natural gas source, it is possible to assume that the composition will be comparatively constant. However, there are also cases in which natural gas from different sources and hence with different compositions is used. It is possible here, for example and in particular, for the carbon dioxide content to fluctuate as well, which creates a particularly strong effect. As a result, however, there is a distinct difference in the air demand in some cases. The gas-air ratio then has to be chosen such that the plant can be operated with the different compositions. But the effect of this is that the margin from the set limit becomes very large during operation with a natural gas that requires a higher gas-air ratio, which in turn increases the risk of overheating. On the other hand, operation becomes more difficult for a natural gas that requires a low gas-air ratio, since the limit greatly reduces the amount of room for manoeuvre.

Thus, a need exists to provide a method that enables safe operation irrespective of the composition of the natural gas used.

### BRIEF DESCRIPTION OF THE FIGURES

Further advantageous details, features and details of the disclosure will be explained in more detail in the context of the exemplary embodiments illustrated in the figures, in which:

FIG. 1 is a schematic diagram of an exemplary apparatus that performs the instant method.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood, that the steps of any method claims need not necessarily be performed in the order in which they are recited, unless so required by the context of the claims. In addition, all references to one skilled in the art shall be understood to refer to one having ordinary skill in the art.

The method according to the disclosure serves for operation of a reformer, especially a reformer of a plant for production of ammonia. The reformer is operated at least with a first hydrocarbon mixture and a second hydrocarbon mixture. In particular, the hydrocarbon mixtures are natural gases of different composition or a hydrocarbon mixture with fluctuating composition. The hydrocarbon mixtures, as well as hydrocarbons, may also have other constituents. Typically, these hydrocarbon mixtures additionally include carbon monoxide, carbon dioxide, hydrogen and/or nitrogen. The reformer has a primary reformer; the primary reformer is supplied with a first gas stream. The reformer additionally has a secondary reformer. The secondary reformer is supplied with the semifinished product stream from the primary reformer and an air stream. The first gas stream and the air stream are used to form the quotient of first gas stream divided by the air stream. A threshold value is defined (set, preset). Typically, the threshold value according to the prior art for the quotient of the first gas stream divided by the air stream is defined and compared therewith. If the value goes below the threshold value, the reformer is shut down in order to avoid damage through overheating.

The first gas stream and the air stream are preferably detected and calculated as molar flow rates in mol/s. These may also be detected differently. What is essential is that these are always detected and calculated in the same way.

According to the disclosure, the threshold value is compared to the product of the quotient of first gas stream divided by air stream multiplied by a factor H, wherein the factor is defined depending on the chemical composition of the first gas stream. The threshold value is integrated comparatively deep within the safety system of the plant and can therefore itself be altered only in a complex manner, in order to assure the safety of the plant. The use of the factor H enables adjustment during operation, which can be ascertained using a verified natural gas composition.

If, for example, exactly two hydrocarbon mixtures of respectively known composition are used in a plant, it is possible to define the two factors H at the design stage, such that the plant can be switched during operation effectively from one state of operation with the first hydrocarbon mixture to another state of operation with the second hydrocarbon mixture. For the first hydrocarbon mixture, for example, the factor H(1) is defined and, for the second hydrocarbon mixture, the factor H(2). If a third hydrocarbon mixture should also be used at a later stage, for this third hydrocarbon mixture, it is likewise possible to ascertain the factor H(3) for the third hydrocarbon mixture.

In a further embodiment of the disclosure, the secondary reformer is an autothermal reformer.

In a further embodiment of the disclosure, the primary reformer is a pre-reformer or has a pre-reformer.

In a further embodiment of the disclosure, the factor H is defined in accordance with the molar concentrations of methane, ethane, propane, and butane. Methane is typically the main component in natural gas. Depending on the origin of the natural gas, however, there are also longer-chain hydrocarbons. Butane includes n-butane, and 2-methylpropane. Molar concentration is reported in mol/mol.

In a further embodiment of the disclosure, the factor H is defined in accordance with the molar concentration of methane, ethane, propane, butane, pentane, and hexane. Thus, small amounts of the actually liquid hydrocarbons are also taken into account. Here too, pentane and hexane each include all the isomers.

In a further embodiment of the disclosure, the factor H is defined in accordance with the molar concentration of methane, ethane, propane, butane, pentane, hexane, carbon monoxide, hydrogen, and nitrogen. It is thus also possible to take account of further components present in the hydrocarbon mixture.

In a further embodiment of the disclosure, the factor H is defined as:

$$H = \frac{F ( current )}{F ( 0 )}$$

In this formula, F(current) is an F value of the current gas composition and F(0) is the F value of the gas composition for which the reformer is designed and for which the threshold value is defined.

The F value is calculated by the following formula:

$$F = \frac{6 N ( C 1 ) + 14 N ( C 2 ) + 20 N ( C 3 ) + 26 N ( C 4 ) + 32 N ( C 5 ) + 38 N ( C 6 ) + 2 N ( CO ) + 2 N ( H ) - 6 N ( N )}{100}$$

In this formula, N(C1) is the molar concentration of CH₄, N(C2) is the molar concentration of C₂H₆, N(C3) is the molar concentration of C₃H₈, wherein N(C4) is the molar concentration of C₄H₁₀, N(C5) is the molar concentration of C₅H₁₂, N(C6) is the molar concentration of C₆H₁₄, N(CO) is the molar concentration of carbon monoxide, N(H) is the molar concentration of hydrogen and N(N) is the molar concentration of nitrogen.

The special feature is that this specific factor H achieves very good thermal stability with a simultaneously extremely constant ratio of hydrogen to nitrogen.

In a further embodiment of the disclosure, the gas composition is detected. This can preferably be effected online. Alternatively, this can also be affected by sampling and analysis in the laboratory. This enables particularly variable use of any desired sources of hydrocarbon mixtures, especially natural gases. This also assures an increase in safety since an incorrect definition of the hydrocarbon mixture is not a possible source of error.

In a further embodiment of the disclosure, the factor H is used for controlled adjustment of the air stream in the event of changes in load and/or changes in the composition of the first gas stream. The first gas stream is thus actively varied as the factor H varies, such that the amount of gas and in particular amount of oxygen supplied is matched directly to the altered composition of the hydrocarbon mixture.

The method according to the disclosure is elucidated in detail hereinafter by a working example shown in the drawing.

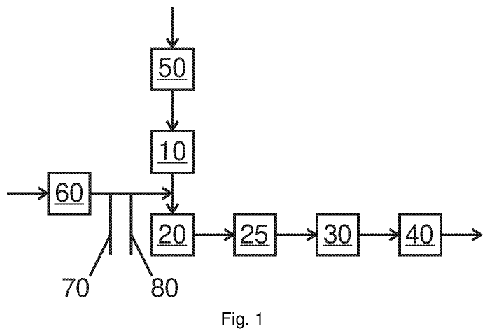

FIG. 1 shows the apparatus for performance of the method according to the disclosure. The hydrocarbon mixture, especially a natural gas, is first guided past a gas sensor 50 into the primary reformer 10. This detects the first gas stream quantitatively. In the primary reformer 10, there is a partial reaction with steam to give hydrogen and carbon monoxide (steam reforming). The semifinished product gas stream coming from the primary reformer 10 is combined with an air stream and supplied to the secondary reformer 20. The air stream is created by means of an air compressor 60, and a pressure sensor 70 and a temperature sensor 80 are used to detect pressure and temperature in order thus to be able to convert the volume flow rate in the compressor to a quantitative air flow. Downstream of the secondary reformer 20, the gas is cooled and passed through a CO conversion to increase the hydrogen yield, and then the carbon dioxide and other components that are unwanted in the synthesis are separated from the gas stream in a process gas cleaning operation 30, and hence a mixture of hydrogen and nitrogen is introduced into the converter circuit 40 for ammonia synthesis.

### REFERENCE NUMERALS

10 primary reformer
20 secondary reformer
25 CO conversion
30 process gas cleaning
40 converter circuit
50 gas sensor
60 air compressor
70 pressure sensor
80 temperature sensor

What is claimed is:

1. A method of operating a reformer, wherein the reformer is operated at least with a first hydrocarbon mixture and a second hydrocarbon mixture, wherein the reformer has a primary reformer and a secondary reformer, the method comprising:
supplying the primary reformer with a first gas stream;
supplying the secondary reformer with a semifinished product gas stream from the primary reformer and with an air stream, wherein the first gas stream and the air stream are used to form the quotient of the first gas stream divided by the air stream, wherein a threshold value is defined; and
shutting down the reformer below the threshold value, wherein the threshold value is compared with a product of a quotient of the first gas stream divided by the air stream multiplied by a factor H, wherein the factor H is defined depending on the chemical composition of the gas stream.

2. The method according to claim 1 wherein the secondary reformer is an autothermal reformer.

3. The method according to claim 1 wherein the factor H is defined in accordance with the molar concentration of methane, ethane, propane, and butane.

4. The method according to claim 3, wherein the factor H is defined in accordance with the molar concentration of methane, ethane, propane, butane, pentane, and hexane.

5. The method according to claim 4 wherein the factor H is defined in accordance with the molar concentration of methane, ethane, propane, butane, pentane, hexane, carbon monoxide, hydrogen, and nitrogen.

6. The method according to claim 5, wherein the factor H is defined as:
$$H = \frac{F ( current )}{F ( 0 )}$$
wherein F(current) is an F value of the current gas composition, wherein F(0) is the F value of the gas composition for which the reformer is designed and for which the threshold value is defined, wherein the F value is calculated by the following formula:
$$F = \frac{6 N ( C 1 ) + 14 N ( C 2 ) + 20 N ( C 3 ) + 26 N ( C 4 ) + 32 N ( C 5 ) + 38 N ( C 6 ) + 2 N ( CO ) + 2 N ( H ) - 6 N ( N )}{100}$$
wherein N(C1) is the molar concentration of CH₄, wherein N(C2) is the molar concentration of C₂H₆, wherein N(C3) is the molar concentration of C₃H₈, wherein N(C4) is the molar concentration of C₄H₁₀, wherein N(C5) is the molar concentration of C₅H₁₂, wherein N(C6) is the molar concentration of C₆H₁₄, wherein N(CO) is the molar concentration of carbon monoxide, wherein N(H) is the molar concentration of hydrogen, wherein N(N) is the molar concentration of nitrogen.

7. The method according to claim 5, further comprising:
detecting the gas composition.

8. The method according to claim 1, further comprising:
determining a change in load of the first gas stream; and
controlling the factor H based on the determination.

9. The method according to claim 1, further comprising:
determining a change in composition of the first gas stream; and
controlling the factor H based on the determination.
